(19) United States
(12) Patent Application Publication
(10) Pub. No.: US 2019/0300108 A1
(43) Pub. Date: Oct. 3, 2019

(54) Wheel with Drive Unit for a Vehicle , Method for Mounting a Wheel, and Sealing Device for Sealing a Bearing Device of a Wheel

(71) Applicant: UJET S.A., Leudelange (LU)

(72) Inventors: Patrick David, Blaustein (DE); Timo Speidel, Ulm (DE)

(21) Appl. No.: 16/302,814

(22) PCT Filed: May 15, 2017
(86) PCT No.: PCT/EP2017/061570

§ 371 Date: Nov. 19, 2018

(30) Foreign Application Priority Data
May 19, 2016 (DE) 10 2016 109 221.5

(51) Int. Cl. B62M 7/12; B60K 7/00; B60B 27/00; B62K 25/04; B62L 1/00; F16C 33/78; H02K 5/16; H02K 7/00; H02K 7/08; H02K 7/102; H02K 9/22; H02K 21/22; H02K 15/08; H02K 15/10; H02K 15/04; H02K 15/12

(52) U.S. Cl. CPC B62M 7/12; B62K 11/00; B60B 27/0052; B62K 25/04; B62L 1/00; F16C 33/78; H02K 5/165; H02K 7/006; H02K 7/088; H02K 7/102; H02K 9/22; H02K 21/22; H02K 15/08; H02K 15/105; H02K 15/0407; H02K 15/12; B62K 2202/00; B60K 7/0007

(57) ABSTRACT

The electrical drive of vehicles is not optimally achieved.

The invention relates to a wheel (10) having a drive unit for a vehicle, in particular for a motor scooter (1), a quad bike, or a passenger automobile, wherein the wheel (10) comprises the following:
an inner ring (20) formed as a stator, which is connected to a wheel suspension (15) of the wheel (10);
a rim ring (30) formed as a rotor having an axis of rotation (33), wherein the rim ring (30) revolves externally around the inner ring (20) and the axis of rotation (33) and the mounting axis (23) extend at least substantially parallel to one another,

wherein the wheel suspension (15) is arranged spaced apart acentrically from the axis of rotation (33).

The invention relates to a wheel having a drive unit for a vehicle, in particular for a motor scooter, and a method for mounting a wheel having a drive and a sealing unit for sealing a bearing device of a wheel.

Motor scooters equipped with electrical drives are known. Electrically-driven motor scooters are typically driven by an electric motor which is arranged below the vehicle seat and drives the rear wheel via a belt or a chain.

Furthermore, hub motors are known, which are used in electric bicycles or pedelecs. In this case, the motor is seated centrally supported on the front or rear wheel, so that the wheel is driven via a centrally arranged shaft.

One disadvantage of traditional wheel hub motors is that they transmit a relatively low torque to the wheel because of their construction. In addition, hub motors result in a high weight of the wheel, which in turn results in a driving feeling perceived as unpleasant by the driver.

DE 10 2011 111 352 B4 describes an electric motor, which is conceived as an external rotor motor having ironless winding. The weight is reduced by dispensing with iron between the conductors of the electric motor.

Proceeding from this prior art, it is the object of the present invention to provide a wheel having a drive unit for a vehicle, which provides an acentric suspension and transmits a high torque with a low overall weight.

The object is solved by a wheel having a drive unit for a vehicle according to claim 1, a method according to claim 17, and a sealing device according to claim 20.

In particular, the object is solved by a wheel, the wheel comprising the following:

an inner ring formed as a stator, which is connected to a wheel suspension of the wheel;

a rim ring formed as a rotor having an axis of rotation, wherein the rim ring revolves externally around the inner ring and the axis of rotation and the mounting axis extend at least substantially parallel to one another, wherein the wheel suspension is arranged spaced apart acentrically from the axis of rotation.

The wheel thus essentially consists of a rim ring, on which the tire can be attached, and an inner ring. The rim ring and the inner ring together form an electric motor. The described wheel thus itself forms a drive unit for a vehicle. In this case, the rim ring acts as a rotor and the inner ring acts as a stator. It is possible by way of this arrangement to dispense with a typically provided, centrally arranged hub. The wheel thus becomes lighter.

It is furthermore possible by way of this arrangement that the wheel suspension is arranged spaced apart acentrically from the axis of rotation of the rim ring. An acentric arrangement of the wheel suspension can be desired, for example, for aesthetic reasons. However, it is also made possible to largely dispense with normally provided spokes. It merely has to be ensured that the inner ring is fixedly connected to a steering unit of the vehicle via the wheel suspension. Weight is thus again saved.

In one embodiment, a bearing device designed for the rotatable bearing of the rim ring can be provided, wherein the bearing device is arranged on the inner ring and on the rim ring. The bearing device can be a roller bearing or also a magnetic bearing.

A bearing device can be provided for the rotatable bearing of the rim ring. In particular the use of roller or magnetic bearings has the advantage that only a small amount of friction results between inner ring and rim ring.

In one embodiment, the bearing device can comprise at least a first and a second bearing, wherein the first and the second bearing are arranged alternately opposing on the inner ring and/or on the rim ring.

A uniform force transmission between inner ring and rim ring can be ensured by the use of two bearings, for example, by two roller bearings. It is furthermore possible to use two small bearings, so that a compact construction of the wheel is enabled.

In one embodiment, a sealing device can be provided on the bearing device.

If the bearing device is arranged on the outer sides of the inner ring and the rim ring, it is advantageous if the bearing device is protected from environmental influences such as dirt or water. A sealing device can be provided for this purpose. The service life of the wheel is extended by the sealing device.

In one embodiment, the sealing device can be designed for sealing off the bearing device at a standstill of the rim ring and releasing the bearing device during the revolution of the rim ring.

If a sealing device is provided on the bearing device, friction can occur between the sealing device and the moving bearing in operation of the wheel. It is therefore advantageous if the sealing device is designed for releasing the bearing device during the revolution of the rim ring. Releasing the bearing device can mean in this context that in the released state, no contact exists between at least a part of the bearing device and the sealing device. The sealing device in particular is thus protected. Furthermore, the friction is reduced and the efficiency of the wheel is increased.

In one embodiment, the sealing device can be designed for releasing the bearing device in dependence on centripetal forces acting on the rim ring.

In the described embodiment, the fact is utilized that due to the revolution of the rim ring centripetal forces form thereon, which forces can be used to release the bearing device. In the described embodiment, no additional devices are thus necessary to ensure a release of the bearing device.

In a further embodiment, the sealing device can be designed to release the bearing device in dependence on air pressure changes generated by the revolution of the rim ring.

It is thus also possible that air pressure is used to release the bearing device. For example, an air flow generated during the travel of a vehicle can be channeled such that the sealing device releases the bearing device. A very efficient option is thus provided to use the existing air flow to cause a release of the bearing device.

In a further embodiment, the sealing device can be designed for releasing the bearing device in dependence on magnetic forces acting on the sealing device.

A further option for releasing the bearing device is the use of magnetic forces. For example, an electromagnet could be arranged on the sealing device which keeps the sealing device at a distance from the bearing device. It is advantageous in this case that electromagnets can be switched arbitrarily and can therefore be switched on or off independently of the status of the vehicle.

In one embodiment, a plurality of transverse ribs can be provided on the inner side of the inner ring, which are arranged at least substantially parallel to the axis of rotation.

The transverse ribs enhance the stability of the inner ring, since they result in stiffening of the inner ring. The transverse ribs are used in particular to absorb forces which act in the direction of the center point of the wheel. These are in particular the normal travel forces which act from the roadway on the wheel.

Furthermore, the transverse ribs can be used to provide a cooling of the stator. The transverse ribs can thus assume a double function, on the one hand, as a stability means and, on the other hand, as a coolant. A very high efficiency of the employed means is thus ensured. In one embodiment, the transverse ribs are manufactured from a heat-conducting material.

In one embodiment, at least one longitudinal rib can be provided on the inner side of the inner ring, which extends around the inner circumference of the inner ring and is arranged at least substantially perpendicular to the axis of rotation.

A longitudinal rib which extends around the inner circumference of the inner ring can result in further stiffening of the inner ring. In particular lateral forces, which occur, for example, in the event of an inclination of the wheel or other impacts from the side, are absorbed via the longitudinal rib. In addition to the advantages of enhanced stiffness of the inner ring, a longitudinal rib can result in improvement of the aerodynamic properties of the wheel, since the flow of lateral winds through the wheel can be controlled.

In one embodiment, a plurality of winding strands can be arranged on an outer side of the inner ring and a magnet device can be arranged opposing each winding strand on the inner side of the rim ring, wherein the magnet devices are arranged having alternating polarites.

The winding strands can be arranged such that the winding strands have current flowing through them substantially parallel to the axis of rotation of the rim ring in operation. The winding strands can thus be arranged in a meandering shape on the outer side of the inner ring.

The magnet devices can be arranged such that in each case one pole of a magnet device faces in the direction of the center point of the rim ring and the second pole of the magnet device faces outward, away from the center point of the rim ring. The magnetic field of a magnet device therefore exits substantially perpendicularly out of the rim ring, so that a force for driving the wheel is generated when a current flows through the winding strands. This force, which is also called a Lorentz force, is induced by the known interaction of conductors through which electricity flows and magnetic fields.

Since the winding strands are only arranged on the outer side of the inner ring, the direction of the current changes in each winding strand in a top view. If the magnet devices are arranged having alternating polarities, it is ensured that one magnet device is always arranged corresponding to the flow direction of the opposing winding strand.

In one embodiment, one winding strand can comprise three conductor tracks arranged in a meandering shape in each case, wherein an insulation device can be arranged between each of the conductor tracks.

The use of three conductor tracks has the advantage that the current direction thereof can be controlled individually. During the revolution of the rim ring, it is advantageous if the current direction of a conductor track is always controlled corresponding to the opposing magnet device, so that all conductor tracks always contribute to the power generation.

The insulation devices can be extrusion coated using thermoplastic and/or extrusion coated using thermoset plastic.

The insulation devices can thus guarantee the required insulation between the conductor tracks, on the one hand, and can ensure the secure hold of the conductor tracks on the inner ring, on the other hand.

In one embodiment, the conductor tracks can be adhesively bonded and/or adhesively bonded with film on the outer side of the inner ring.

Adhesive bonding of the conductor tracks on the outer side of the inner ring enables simple production with low expenditure.

In one embodiment, the conductor tracks can be formed planar having a low height in relation to the width. In particular, a height of ½, ⅕, 1/10, 1/15, 1/20, or 1/50 of the width of the conductor tracks can be provided.

If the conductor tracks are formed planar, simple production is enabled, since the conductor tracks can simply be stamped out of a piece of sheet metal or, for example, cut out via laser.

In one embodiment, a brake device can be arranged on the wheel suspension, which can be designed for engaging from the inside in a brake disk fixedly connected to the rim ring during a braking procedure.

To enable braking of the wheel, a disk brake can be provided. In this case, it is advantageous to enhance the braking power by using a brake disk having a large diameter. Because the wheel is designed as an external rotor motor, it is very easily possible that the brake disk is fastened on the rim ring, and the brake device engages from the inside in the brake disk. The proposed construction thus enables the enhancement of the braking performance of the wheel.

In one embodiment, the wheel suspension can have a suspension device, wherein the wheel suspension can be designed such that a rotation about the mounting axis takes place.

Due to the use of a suspension device on the wheel suspension, the suspension and/or shock absorption of the wheel can be set easily.

The object is furthermore solved by a method for mounting a wheel as described above, comprising the following:
manufacturing conductor tracks from sheet metal;
attaching the conductor tracks to the outer side of the inner ring of the wheel;
insulating the conductor tracks.

The conductor tracks can thus be manufactured from sheet metal, and then be attached to the outer side of the inner ring of the wheel. A very simple option is thus provided for fastening the conductor tracks on the wheel. A complex winding, as is otherwise required in electric motors, is omitted.

In one embodiment, the manufacturing of the conductor tracks can comprise stamping of the conductor tracks out of a sheet metal or cutting out of a sheet metal. The cutting out can be executed via laser, for example. The described options for manufacturing the conductor tracks enable high-precision and efficient production, which is additionally cost-effective.

In one embodiment, the insulating of the conductor tracks can comprise thermoplastic extrusion coating or thermoset plastic extrusion coating of the conductor tracks.

A very efficient and simple option for insulating the conductor tracks is offered by thermoplastic or thermoset plastic extrusion coating.

Furthermore, the object is solved by a sealing device for sealing a bearing device of an above-described wheel, wherein the sealing device is designed for
sealing the bearing device at a standstill of the rim ring and
releasing the bearing device during the revolution of the rim ring, in particular in dependence on centripetal forces acting on the rim ring.

Similar or identical advantages result as were already described in conjunction with the wheel.

Further advantageous embodiments of the invention result on the basis of the dependent claims.

The invention will be described hereafter by means of several exemplary embodiments, which are explained in greater detail on the basis of figures. In the figures:

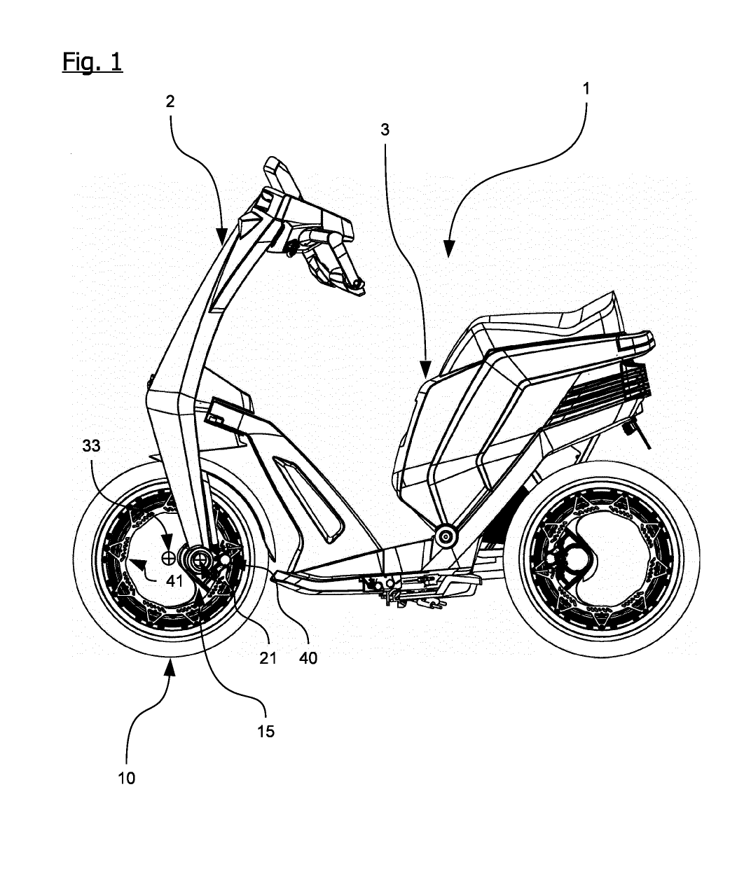

FIG. 1 shows a lateral overall view of an electric motor scooter 1;

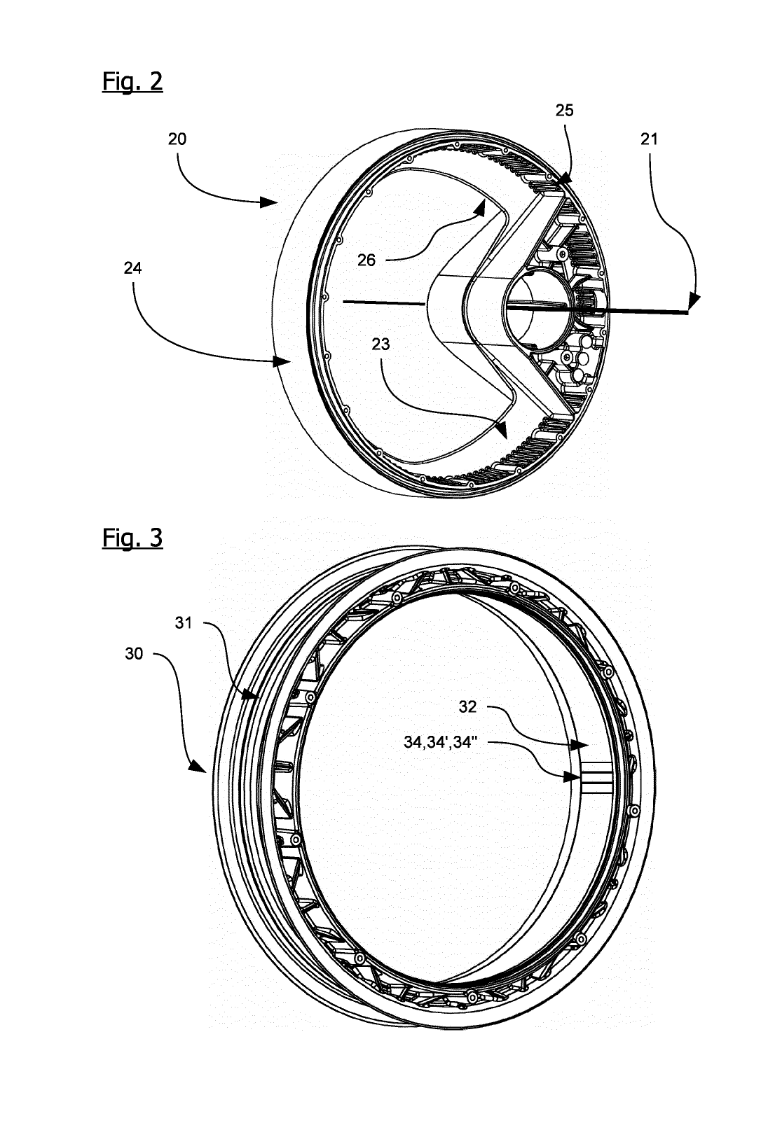

FIG. 2 shows a detail view of an inner ring 20;

FIG. 3 shows a detail view of a rim ring 30 corresponding to the inner ring 20 of FIG. 2;

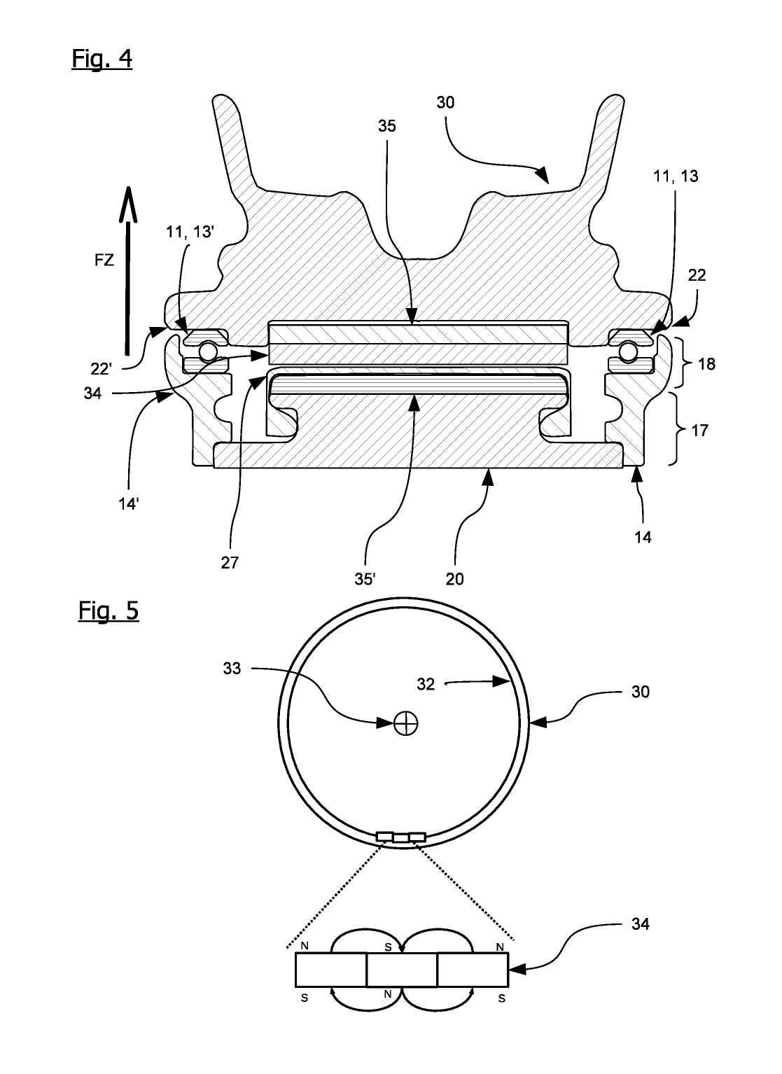

FIG. 4 shows a sectional view of the rim ring 30 and the inner ring 20;

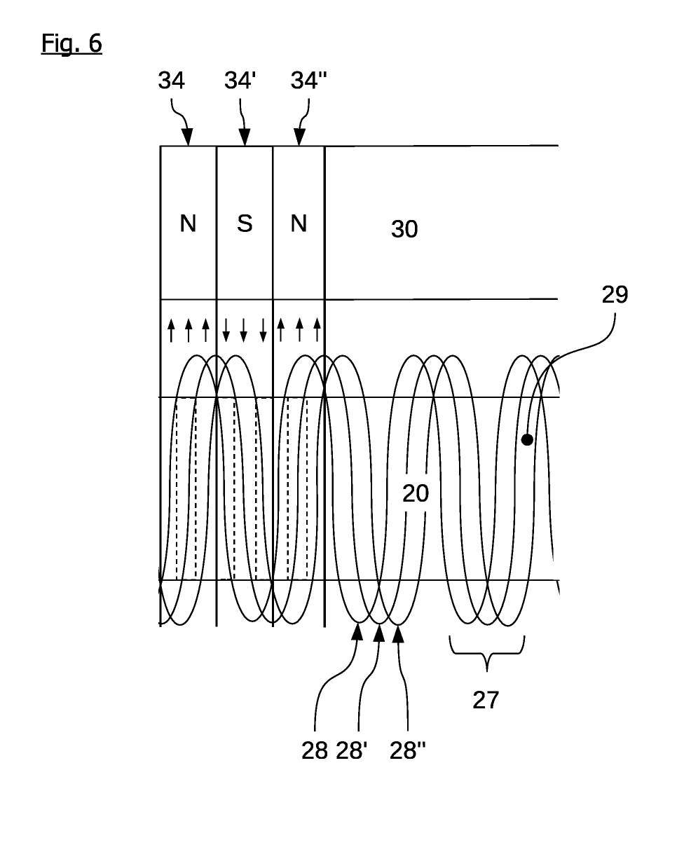

FIG. 5 shows a schematic side view of the rim ring 30 with magnet devices 34;

FIG. 6 shows a schematic illustration of the conductor tracks 28, 28′, 28″ and corresponding magnet devices 34;

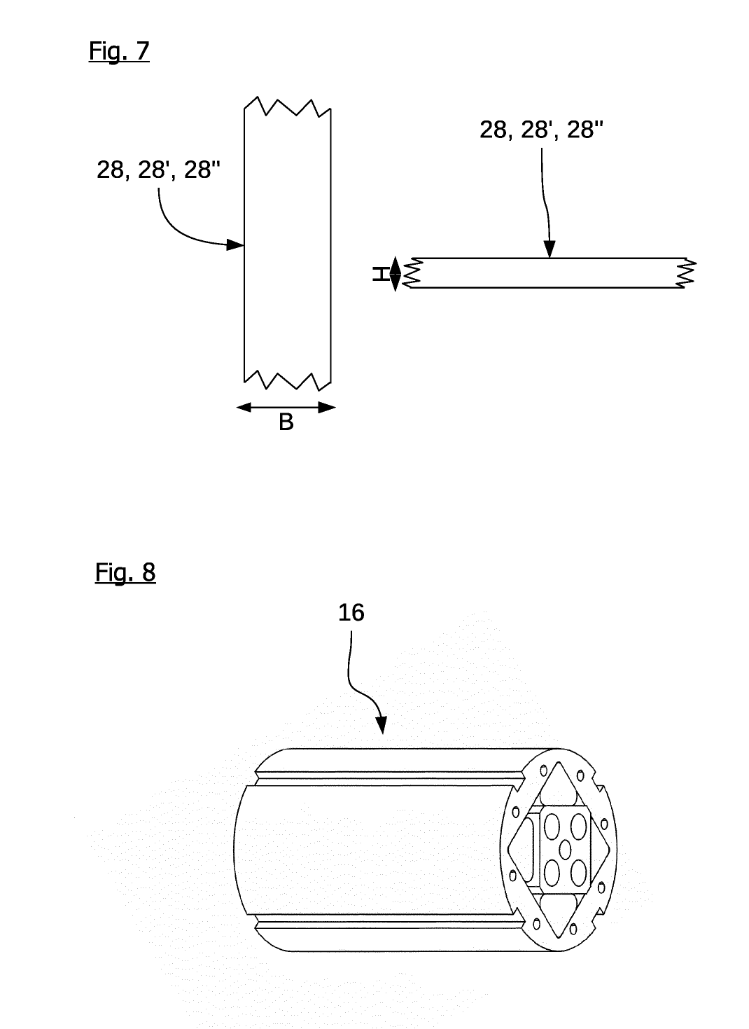

FIG. 7 shows a schematic illustration of an individual conductor track 28;

FIG. 8 shows an illustration of a suspension device 16.

FIG. 1 shows a motor scooter 1 having a front wheel 10 and a rear wheel and also steering unit 2 and battery box 3. The wheel 10 is fixedly connected via a wheel suspension 15 to the steering unit 2 of the motor scooter 1. A mounting axis 21, which extends substantially parallel to an axis of rotation 33, extends through the wheel suspension 15. The axis of rotation 33 extends through the center point of the wheel 10. The wheel 10 is thus connected acentrically to the steering unit 2.

Substantially parallel means in the scope of this application that the substantially parallel elements extend parallel in the scope of conventional manufacturing tolerances.

The acentric suspension of the wheel 10 is enabled in that the wheel 10 acts as a drive of the motor scooter 1. A hub is thus not required. The wheel 10 is designed as an electric motor, wherein the battery box 3 is electrically connected to the wheel 10.

In one embodiment, only the rear wheel is designed as a drive and in another embodiment, only the front wheel is designed as a drive. In further embodiments, it is entirely possible that both the front wheel and also the rear wheel are designed as drives.

The weight of the wheel 10 is significantly reduced by the hub-free and spokeless embodiment of the wheel 10.

FIG. 2 shows a perspective illustration of an inner ring 20 of the wheel 10. The mounting axis 21, on which the wheel suspension 15 for mounting the wheel 10 on the motor scooter 1 is arranged, extends through the inner ring 20. To enhance the stiffness of the inner ring 20, transverse ribs 25 and a longitudinal rib 26 are provided on the inner side of the inner ring 23. The transverse and longitudinal ribs 25, 26 are integral components of the inner ring 20 in the illustrated embodiment. In further embodiments, however, they can also be separate parts, in particular parts made of another material. The transverse ribs 25 are embodied as hollow in the illustrated embodiment, and therefore the total weight of the wheel 10 is kept low.

The inner ring 20 is designed as a stator of an electric motor. For this purpose, winding strands 27, through which a current flows, are provided on the outer side 24 of the inner ring 20. Electrical charge carriers thus move through the winding strands 27.

FIG. 3 shows a perspective illustration of a rim ring 30 designed as a rotor of an electric motor. In the mounted state, the rim ring 30 revolves externally around the inner ring 20. A tire is attached on the outer side 31 of the rim ring 31. Magnet devices 34, 34′, 34″, which can be designed, for example, as permanent magnets, are provided on the inner side 32 of the rim ring 30. The magnet devices 34, 34′, 34″ are arranged in alternating polarity, and therefore alternately north, south, and again north face in the direction of the center of the inner ring 30. The magnetic field generated by the magnet devices 34, 34′, 34″ thus faces substantially perpendicularly out of the magnet devices 34, 34′, 34″ into the center of the inner ring 30. As already described in conjunction with FIG. 2, winding strands 27 extend on the outer side 24 of the inner ring 20. A Lorentz force, which results in the rotation of the rim ring 30, is generated by the interaction of the winding strands 27 through which current flows and the magnet devices 34, 34′, 34″.

FIG. 3 shows a sectional view of the wheel 10 having inner ring 20 and rim ring 30 in the mounted state. The rim ring 30 and the inner ring 20 are connected to one another via a bearing device 11 so they are rotationally movable. The bearing device 11 is designed in the illustrated embodiment as a first and second roller bearing 13, 13′. The first and second roller bearings 13, 13′ are each arranged opposing on the outer edges of the inner ring 22, 22′ and the outer edges 22, 22′ of the rim ring 30. The use of two roller bearings 13, 13′ enables a compact construction, since small roller bearings can be used on the outer edges 22, 22′ of the rim ring 30. In addition, a uniform force transmission and lower material wear are achieved. In one embodiment, the bearing device 11 can also be embodied as a magnetic bearing. A magnetic bearing offers the advantage that the friction and thus the material wear are reduced further.

Because the roller bearings 13, 13′ are arranged on the outer edges 22, 22′ of the rim ring, the roller bearings 13, 13′ have to be protected from external environmental influences. In particular, the entry of dirt or water has to be effectively prevented. In the illustrated embodiment, sealing devices 14, 14′, which protect the roller bearings 13, 13′, are provided for this purpose. The sealing device 14, 14′ is formed from a sealing body 17 and a seal lip 18. In the illustrated embodiment, the sealing body 17 is fastened on the inner ring 20. The seal lip 18 is guided externally around the roller bearings 13, 13′. In the illustrated embodiment of FIG. 3, on the one hand, the sealing body 17 prevents dirt or water from being able to penetrate into the inner region of the inner ring 20 and the seal lip 18 prevents dirt or water from being able to penetrate into one of the roller bearings 13, 13′.

The protection from environmental influences by the sealing device 14, 14′ is necessary in particular when stationary. During travel, i.e., the rotation of the rim ring 30 around the inner ring 20, the risk of entering dirt is less, since water and/or dirt is displaced by the wheel 10. In a further embodiment, the sealing device 14, 14′ is fastened on the rim ring 30 for this purpose such that the seal lip 18 rotates with the rim ring 30. Friction can thus occur between the seal lip 18 and the roller bearings 13, 13′. To prevent the friction, the centripetal force FZ generated by the rotation of the rim ring 30 can be used. In particular, the centripetal force FZ can be used to guide the seal lip 18 away from the bearings 13, 13′, so that no friction occurs between roller bearings 13, 13′ and seal lip 18.

As already described above, magnet devices 34 are arranged on the rim ring 30 and winding strands 27 are arranged opposite thereto on the inner ring to provide the electrical drive. A small air gap is provided between the winding strands 27 and the magnet devices 34. Steel backs 35, 35′ are provided on the rear side of the winding strands 27 (side toward the center point of the inner ring) and on the rear side of the magnet devices 34 (side outward).

As shown in FIG. 5, the magnetic fields of the magnet device 34 act in the direction of the axis of rotation of the rim ring 33. The most perpendicular possible conduction of the magnetic field lines out of the magnet devices 34, 34′, 34″ results in a maximization of the generated Lorentz force. The magnet devices 34, 34′, 34″ are designed for this purpose such that one magnetic pole faces in each case toward the axis of rotation 33.

The interaction of the magnet devices 34, 34′, 34″ and the winding strands 27 is schematically illustrated in FIG. 6. The upper region of FIG. 6 shows the arrangement of the magnet devices 34, 34′, 34″ on the inner side 32 of the rim ring 30. The arrangement of the winding strands 27 on the outer side 24 of the inner ring 20 is illustrated in the lower region of FIG. 6.

One winding strand 27 is formed from three conductor tracks 28, 28′, 28″. A current flows through each conductor track 28, 28′, 28″. The conductor tracks 28, 28′, 28″ are arranged in a meandering shape on the outer side 24 of the inner ring 20. The conductor tracks 28, 28′, 28″ thus extend substantially parallel to the axis of rotation 33 of the rim ring 30. A current flows through the conductor tracks 28, 28′, 28″, and therefore a Lorentz force is generated by the interaction with the magnetic field generated by the magnet devices 34, 34′, 34″. In this case, the conductor tracks 28, 28′, 28″ are arranged such that the current direction is always adapted to the opposing magnet devices 34, 34′, 34″. During the rotation of the rim ring 30, the current directions of the conductor tracks 28, 28′, 28″ are then switched accordingly by a controller.

This ensures that all conductor tracks 28, 28′, 28″ always contribute to the force generation. The illustrated embodiment thus results in a very efficient usage of the applied energy. This is desirable in particular in the case of electrically driven vehicles, since the range of the vehicles is thus extended.

Insulation devices 29 are provided between the conductor tracks 28, 28′, 28″. The insulation device 29 can be a thermoset plastic, for example. Thermoplastics are also conceivable. The use of thermoset plastics or thermoplastics has the advantage that they can be extruded around the inner ring 20. On the one hand, the conductor tracks 28, 28′, 28″ are thus held on the inner ring 20 and an electromagnetic permeability is ensured.

FIG. 6 schematically shows a conductor track 28, 28′, 28″. The conductor track 28, 28′, 28″ is preferably formed planar. This means that the area applied to the outer side 24 of the inner ring 20 is large. In particular, the width B is thus significantly greater than the height H of the conductor track 28, 28′, 28″. Such an embodiment of the conductor track 28, 28′, 28″ enables the simple production of the conductor track 28, 28′, 28″, since it can simply be stamped out of sheet metal or cut out via laser. In addition, such an embodiment, in which the height H comprises ½, ⅕, 1/10, 1/15, 1/20, or 1/50 of the width B of the conductor tracks 28, 28′, 28″, enables a compact construction of the wheel 10.

To enhance the driving comfort of the motor scooter 1, the wheel 10 can be connected via a suspension device 16 to the wheel suspension 15. The suspension device 16 is designed as torsion-elastic. The damping and/or spring suspension of the wheel 10 can be set via the suspension device 16.

It is to be noted at this point that all above-described parts, considered alone and in any combination, in particular the details illustrated in the drawings, are claimed as essential to the invention. Modifications thereof are routine for a person skilled in the art.

### LIST OF REFERENCE SIGNS

1 motor scooter

2 steering unit

3 battery box

10 wheel

11 bearing device

13, 13′ first roller bearing, second roller bearing

14, 14′ seal, sealing device

15 wheel suspension

16 suspension device

17 sealing body

18 seal lip

20 inner ring

21 mounting axis

22, 22′ outer edge of the inner ring

23 inner side of the inner ring

24 outer sides of the inner ring

25 transverse rib

26 longitudinal rib

27 winding strand

28, 28′, 28″ conductor tracks

29 insulation device

30 rim ring

31 outer side of the rim ring

32 inner side of the rim ring

33 axis of rotation, axis of rotation of the rim ring

34, 34′, 34″ magnet device

35, 35′ steel backs

40 brake device

41 brake disk

B width of a conductor track

H height of a conductor track

FZ centripetal force

1. A wheel having a drive unit for a vehicle, in particular for a motor scooter, a quad bike, or a passenger automobile, wherein the wheel comprises:
an inner ring formed as a stator, which is connected to a wheel suspension of the wheel;
a rim ring formed as a rotor having an axis of rotation, wherein the rim ring revolves externally around the inner ring and the axis of rotation and the mounting axis extend at least substantially parallel to one another,
characterized in that
the wheel suspension is arranged spaced apart acentrically from the axis of rotation.

2. The wheel according to claim 1,
characterized by
a bearing device designed for the rotatable support of the rim ring, wherein the bearing device is arranged on the inner ring and on the rim ring.

3. The wheel according to claim 2,
characterized in that
the bearing device comprises at least a first and second bearing, wherein the first and the second bearings are arranged opposing alternately on the inner ring and/or on the rim ring.

4. The wheel according to claim 2,
characterized in that
a sealing device, in particular an electrically actuable sealing device, is provided on the bearing device.

5. The wheel according to claim 4,
characterized in that
the sealing device is designed for:
sealing the bearing device at a standstill of the rim ring; and
releasing the bearing device during the revolution of the rim ring.

6. The wheel according to claim 5,
characterized in that
the sealing device is designed for releasing the bearing device in dependence on centripetal forces acting on the rim ring.

7. The wheel according to any one of the preceding claims, in particular according to claim 5,
characterized in that
the sealing device is designed for releasing the bearing device in dependence on air pressure changes generated by the revolution of the rim ring.

8. The wheel according to claim 5,
characterized in that
the sealing device is designed for releasing the bearing device in dependence on magnetic forces acting on the sealing device.

9. The wheel according to claim 1,
characterized in that
a plurality of transverse ribs (25), which are arranged at least substantially parallel to the axis of rotation (33), is provided on the inner side (23) of the inner ring (20).

10. The wheel according to claim 1,
characterized in that
at least one longitudinal rib is provided on the inner side of the inner ring, which extends around the inner circumference of the inner ring is and is arranged at least substantially perpendicular to the axis of rotation.

11. The wheel according to claim 1,
characterized in that
a plurality of winding strands is arranged on the outer side of the inner ring; and
a magnet device is arranged opposing each winding strand on the inner side of the rim ring, wherein the magnet devices are arranged having alternating polarity.

12. The wheel according to claim 11,
characterized in that
the winding strands each comprise three conductor tracks kw arranged in a meandering shape, wherein an insulation device is arranged between each of the conductor tracks.

13. The wheel according to claim 12,
characterized in that
the conductor tracks are:
adhesively bonded,
adhesively bonded flatly with film,
extrusion coated with thermoplastic, and/or
extrusion coated with thermoset plastic
on the outer side of the inner ring.

14. The wheel according to any one of the preceding claims, in particular according to claim 11,
characterized in that
the conductor tracks are formed planar having a lesser height in relation to the width, in particular having a height of ½, ⅕, 1/10, 1/15, 1/20, or 1/50 of the width (B) of the conductor tracks.

15. The wheel according to claim 1,
characterized in that
a brake device is arranged on the wheel suspension, which is designed for engaging from the inside in a brake disk fixedly connected to the rim ring during a braking procedure.

16. The wheel according to claim 1,
characterized in that
the wheel suspension has a suspension device, and wherein the wheel suspension is embodied such that a rotation takes place about a mounting axis.

17. A method for mounting a wheel having a drive according to claim 1, comprising the following:
manufacturing conductor tracks from a sheet metal;
applying, in particular adhesively bonding, the conductor tracks on the outer side of the inner ring of the wheel;
insulating the conductor tracks.

18. The method according to claim 17,
characterized in that
the manufacturing of the conductor tracks comprises
stamping the conductor tracks out of a sheet metal; or
cutting, in particular via laser, out of a sheet metal.

19. The method according to claim 17,
characterized in that
the insulating of the conductor tracks comprises
a thermoplastic extrusion coating; or
a thermoset plastic extrusion coating
of the conductor tracks.

20. A sealing device for sealing a bearing device of a wheel,
characterized in that
the sealing device is designed for
sealing the bearing device at a standstill of the rim ring; and
releasing the bearing device during the revolution of the rim ring, in particular in dependence on centripetal forces acting on the rim ring.
